(19) United States
(12) Patent Application Publication
(10) Pub. No.: US 2003/0166406 A1
(43) Pub. Date: Sep. 4, 2003

(54) Multi-format wireless synchronization channel

(76) Inventors: John K. Burgess, Morristown, NJ (US); Douglas N. Knisely, Wheaton, IL (US); Orlett Wanda Pearson, Aurora, IL (US); Eshwar Pittampalli, Randolph, NJ (US); David Albert Rossetti, Randolph, NJ (US)

Correspondence Address: Docket Administrator (Room 3J-219), Lucent Technologies Inc., 101 Crawfords Corner Road, Holmdel, NJ, 07733-3030, US

(21) Appl. No.: 10/086,502

(22) Filed: Mar. 1, 2002

(51) Int. Cl. H04B 7/005

(52) U.S. Cl. 455/502; 455/450; 455/509

(57) ABSTRACT

A flexible synchronization message format permits older mobiles as well as newer mobiles to access a wireless communication network. Three types of synchronization messages are time division multiplexed unto the synchronization channel. A first message is interpreted by the newer mobiles and some older mobiles. A second message is interpreted by a second set of older mobiles and a third message is interpreted by a final set of older mobiles. The second and third type of messages are formatted so that they will be ignored by the newer mobiles so that the newer mobiles will not follow instructions associated with older standards and, thereby, not take advantage of options offered under the newer standards. In another embodiment, the frequency with which each of the three messages is transmitted is varied to provide preferential treatment to a particular message type.

### BACKGROUND OF THE INVENTION

1. Field of the Invention

The present invention relates to wireless communications; in particular, the synchronization channel used for accessing the wireless communication network.

2. Description of the Related Art

Accessing a wireless communication network requires that a mobile communication device receive information transmitted from a base station on several channels. For example, the pilot channel identifies the base station and provides timing to the mobile unit, the synchronization channel provides the mobile unit with information used to locate other channels such as a paging channel, a broadcast control channel (BCCH), and a forward common control channel (FCCCH). In older communication systems, such as systems that follow the TIA standard IS-95A or B, the paging channel provides the mobile unit with information on how to make voice or data calls and it also informs the mobile of incoming calls. In newer systems such as systems that follow TIA standard IS-2000 revision A, the BCCH informs the mobile of how to initiate a voice or data call, and the FCCCH informs the mobile of incoming calls. These different standards have evolved as technology has advanced and sometimes make it difficult to configure networks so that both the newer mobiles conforming to the newer standard and the older mobiles conforming to the older standards can access the communications network.

Such a problem exists with regard to messages carried on the synchronization channel. As the standards have changed, the length of messages carried on the synchronization channel has increased. For example, synchronization messages under the IS-95B standard contain 26 octets, and synchronization messages under the IS-2000B standard are variable in length and may be greater than or equal to 28 octets long. Unfortunately, some older mobiles have difficulty interpreting a synchronization message if it is longer than expected. For example, some older mobiles cannot interpret synchronization messages that are longer than 27 octets, and yet another group of older mobiles cannot interpret synchronization messages that are longer than 28 octets. As a result, it is necessary to provide a flexible synchronization messaging format that can be used by different types of older mobiles, while offering the newer mobiles all the advantages provided by the newer technology contained in the newer standards.

### SUMMARY OF THE INVENTION

An embodiment of the present invention provides a flexible synchronization message format that permits older mobiles as well as newer mobiles to access a wireless communication network. Three types of synchronization messages are time division multiplexed unto the synchronization channel. A first message is interpreted by the newer mobiles and some older mobiles. A second message is interpreted by a second set of older mobiles and a third message is interpreted by a final set of older mobiles. The second and third type of messages are formatted so that they will be ignored by the newer mobiles so that the newer mobiles will not follow instructions associated with older standards and, thereby, not take advantage of options offered under the newer standards. In another embodiment, the frequency with which each of the three messages is transmitted is varied to provide preferential treatment to a particular message type. For example, the first message type may be transmitted sixty percent of the time, while the second message type is transmitted 30 percent and the third message type is transmitted 10 percent of the time.

In still another embodiment of the invention, a paging channel is provided with a global redirection message that is addressed to the newer mobiles. This acts as a fail-safe in case one of the newer mobiles acts in accordance with information contained in the synchronization channel message that is meant for older mobiles. When following the instructions contained in the older messages, the newer mobile will access a paging channel that is generally used by the older mobiles. The paging channel in addition to containing information used by the older mobiles also contains the global redirection message which will redirect the newer mobile back to the synchronization channel to receive and interpret a synchronization message meant for the newer mobiles.

### BRIEF DESCRIPTION OF THE DRAWINGS

FIG. 1 illustrates a synchronization channel format;

FIG. 2 illustrates three synchronization message types; and

FIG. 3 illustrates a sequence of time division multiplexed synchronization messages.

### DETAILED DESCRIPTION OF THE INVENTION

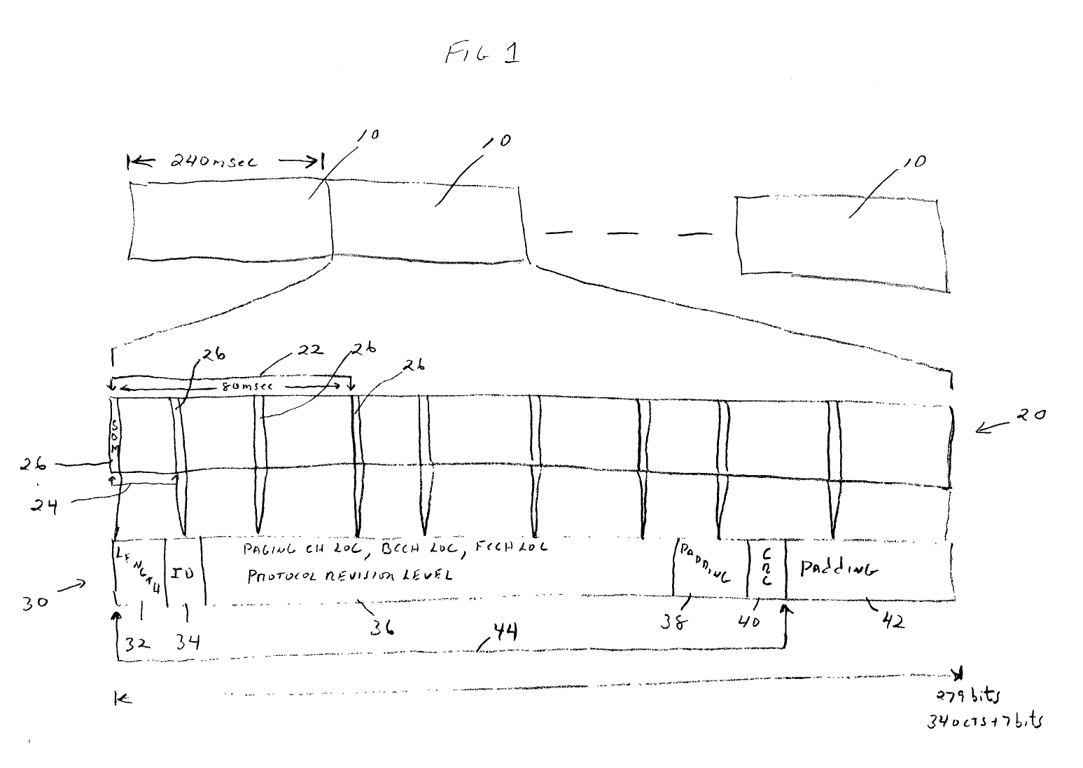

FIG. 1 illustrates the format of a synchronization channel. The synchronization channel contains a sequence of synchronization message frames 10. In a communication system conforming to the IS-95A, IS-95B, IS-2000 revision 0, or IS-2000 revision A standards, each synchronization message frame is 240 milliseconds long. In other communication systems, different synchronization channel formats may be used. Frame sequence 20 illustrates a series of synchronization channel super frames 22 that compose each of synchronization message frames 10. In systems that conform to the above-referenced standards, each synchronization channel super frame is 80 milliseconds long. As a result, each synchronization message frame 10 comprises three synchronization channel super frames 22. Each synchronization channel super frame 22 comprises synchronization channel frames 24. In an embodiment conforming to the above-referenced standards, there are three synchronization channel frames 24 in each synchronization channel super frame 22. Each synchronization channel frame 24 begins with a 1-bit start of message (SOM) field 26. The start of message field bit is set for the first synchronization channel frame 24 in an overall synchronization message frame 10. The remaining start of message fields 26 are not set for each synchronization, channel frame 24 within a particular synchronization message frame 10.

The synchronization message 30 contained in synchronization message frame 10 is interpreted by removing start of message field 26 from each of the synchronization channel frames 24. Synchronization message field 30 contains information such as length field 32, ID field 34, synchronization information field 36, padding 38, CRC field 40 and padding field 42. In systems conforming to the above-referenced standards, the overall length of message field 30 including padding 42 is 279 bits. Length field 32 provides information to the mobile regarding the length of the synchronization message 44 in octets while excluding padding field 42. Field 36 provides the mobile with information such as the location of the paging channel, the highest communication protocol revision level supported by the transmitting base station, the location of the BCCH and FCCCH. It should be recalled that the paging channel is used by older mobiles to access services provided by the wireless network and for notification of incoming communications. Similarly, the BCCH and the FCCCH are used by newer mobiles to get information on accessing the communication network (and newer advanced services), and for notification of incoming communications, respectfully. Padding field 38 and 42 are simply fillers containing unused information and CRC field 40 is an error correction and detection field.

In communication systems conforming to the IS-95A or IS-95B standard (sometimes referred to as protocol revision 5), synchronization message 44 is 26 octets long. In communications systems conforming to the IS-2000 revision 0 standard (sometimes referred to as protocol revision 6), synchronization message 44 is 28 octets long. In the newer systems conforming to the IS-2000 revision A standard (sometimes referred to as protocol revision 7) synchronization message 44 is variable in size and may be greater than or equal to 28 octets long.

The differing lengths of synchronization message 44 make backward compatibility difficult for some older mobiles. For example, a first class of older mobiles cannot accept synchronization messages 44 longer than 27 octets, a second class of older mobiles cannot accept synchronization messages 44 longer than 31 octets, and yet a third class of older mobiles can accept a variable length synchronization message 44.

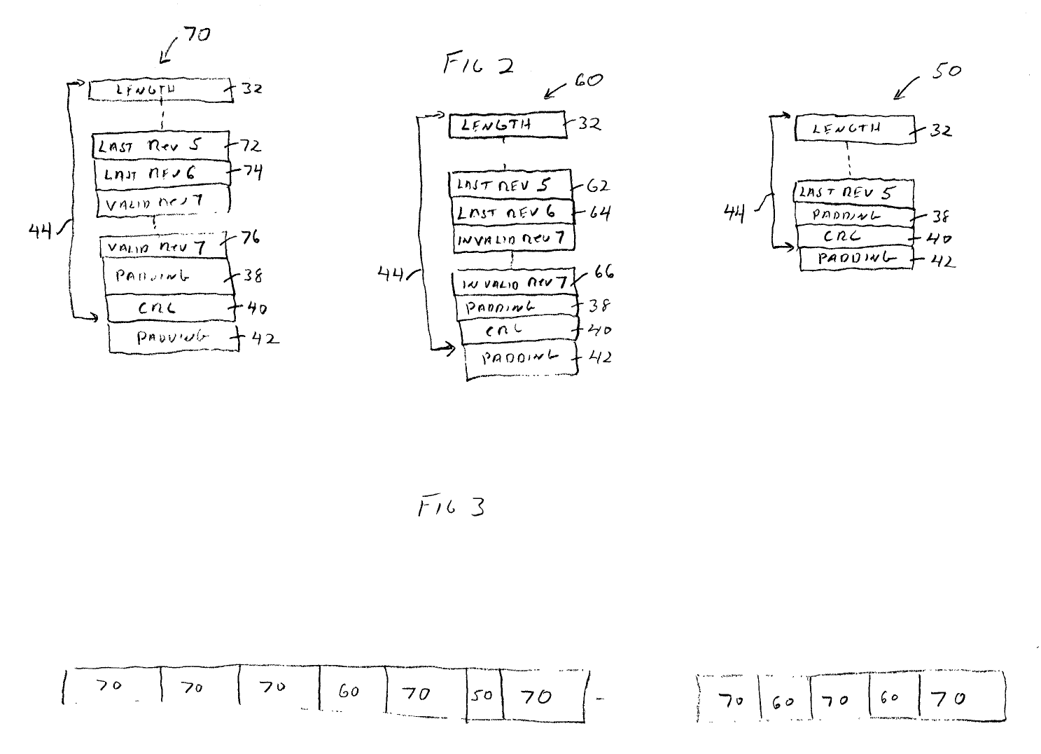

In order to accommodate the capabilities of the different mobiles still in use, three types of synchronization messages 44 are transmitted on the synchronization channel. FIG. 2 illustrates three synchronization messages 50, 60 and 70. Synchronization message 50 has a message field 44 that is 26 octets long where the last field prior to padding field 38 contains a valid protocol revision 5 field. This message is transmitted with a protocol revision level specification of 7, notwithstanding that the message conforms to a protocol revision 5 (IS-95A or B standard) rather than protocol revision 7 and as a result is an invalid message. This type of message will be successfully interpreted by most of the older mobiles including the mobiles that are limited to 27 or less octets in the synchronization message, mobiles that are limited to 31 or less octets in the synchronization message and mobiles that can accept a variable number of octets in the synchronization message. Mobiles conforming to a protocol revision 6 (IS-2000 revision 0 standard) and mobiles conforming to a protocol revision 7 (IS-2000 revision A standard) will ignore this message. These newer mobiles will ignore the message because the message contains information specifying it to be a protocol revision 7 message, but yet has the length of a protocol revision 5 message. As a result, the newer mobiles will treat message type 50 as an invalid message and will continue to wait for a valid synchronization message.

Synchronization message type 60 has a message field 44 that is greater than or equal to 28 octets but less than or equal to 31 octets. In the case of message 60, the end portion of message field 44 includes a last valid protocol revision 5 field 62, followed by a last valid protocol revision 6 field 64, and a invalid protocol revision 7 field 66. In the case of message 60 as in the case of message 50, the protocol revision level label associated with the message will be protocol level 7, notwithstanding that field 66 has an invalid protocol revision 7 field, and as a result is an invalid message. Synchronization message 60 will be successfully decoded by older mobiles that can decode variable length synchronization messages. Message 60 will not be successfully decoded by older mobiles that cannot decode synchronization messages longer than 27 octets. However, synchronization message 60 will be successfully decoded by older mobiles that can decode synchronization messages that are less than or equal to 31 octets long. Synchronization message 60 will be successfully decoded by protocol revision 6 mobiles (IS-2000 revision 0 standard mobiles). Finally, synchronization message 60 will be ignored by protocol revision 7 mobiles (IS-2000 revision A mobiles) because final protocol revision 7 field 66 is invalid. As a result, protocol revision 7 mobiles will consider synchronization message 60 as invalid and will wait for another synchronization message.

The third synchronization message type 70 contains a message field 44 length of greater than or equal to 28 octets. Synchronization message 70 includes a last valid protocol revision 5 field 72, a last valid protocol revision 6 field 74 and a last valid protocol revision 7 field 76. As was the case with synchronization messages 50 and 60, synchronization message 70 contains a protocol revision label of 7. Synchronization message 70 will be successfully decoded by older mobiles that decode variable length synchronization messages. Synchronization message 70 will not be successfully decoded by older mobiles that do not decode longer synchronization messages such as messages longer than 31 octets. Message 70 will be successfully decoded by both protocol revision 6 mobiles (IS-2000 revision 0) and protocol revision mobiles (IS-2000 revision A).

It is possible but not likely that a protocol revision 7 mobile (IS-2000 revision A) will decode either synchronization message 50 or 60. When a protocol revision 7 mobile decodes message 50 or 60 it will default to accessing a paging channel specified in the synchronization message to obtain the information necessary to access the wireless communication network. Unfortunately, when a protocol revision 7 mobile accesses a network using the paging channel, the mobile cannot take advantage of all the services and options that are available to a protocol revision 7 system. As a result, the paging channel contains a global redirection message that is addressed to protocol revision 7 mobiles. The global redirection message instructs the protocol revision 7 mobile to return the synchronization channel to receive another synchronization message such as synchronization message 70. Synchronization message 70 contains information directing the protocol revision 7 mobile to the BCCH and the FCCCH that enable the mobile to access the network while taking advantage of the services available under protocol revision 7.

It should be noted that the length of message field 32 is specified in each of message 50, 60 and 70. In message 50, field 32 indicates a length of 26 octets, notwithstanding that 26 octets is an invalid length for a message containing a protocol revision of 7. Similarly, in message 60 field 32 indicates the actual length of the message even if that length is invalid for a message containing a protocol revision of 7.

FIG. 3 illustrates a sequence 80 of synchronization messages. It can be seen that synchronization messages 70, 60 and 50 are time division multiplexed. The percentage of time provided to a particular synchronization message type can be fixed or variable. In order to maximize the opportunity for protocol revision 7 mobiles to receive synchronization message 70 on an initial reception, a larger percentage of the time is allotted to synchronization message type 70. Since there are fewer older mobiles that cannot accept synchronization message greater than 27 octets long, a minimal amount of time is allotted to synchronization message type 50. For example, it is possible to allot time in time division multiplexed synchronization message sequence 80 such that message type 70 receives approximately 60 percent of the time, synchronization message type 60 receives 30 percent of the time and synchronization message type 50 receives 10 percent of the time. Other time distributions may be used and they may be fixed or variable.

It is desirable to place a synchronization message type 70 between synchronization types 50 and 60. It is also desirable to place several synchronization message type 70s in a row so that a protocol revision 7 type that has been redirected by a global redirection message in a paging channel has a greater probability of immediately receiving a synchronization message 70 rather than a synchronization message type 50 or 60. It is also possible to estimate or measure a redirection time required for a protocol revision 7 mobile to receive a synchronization message type 50 or 60 and to be redirected by the global redirection and paging channel back to the synchronization channel. It would be advantageous to place a synchronization message type 70 a time approximately equal to the redirection time after transmitting a synchronization message type 50 or 60.

We claim:

1. A method for transmitting synchronization messages, comprising the steps of:
transmitting a plurality of synchronization messages having at least two types of synchronization messages, where at least one type of synchronization message is valid and where at least one type of synchronization message is invalid.

2. The method of claim 1, wherein the invalid type of synchronization message has an incorrect length.

3. The method of claim 1, wherein the invalid type of synchronization message has at least one missing field.

4. The method of claim 1, wherein the invalid type of synchronization message has at least one field containing invalid data.

5. The method of claim 1, wherein the invalid type of synchronization message does not conform to a protocol revision specified in the synchronization message.

6. A method for transmitting synchronization messages, comprising the steps of:
transmitting a plurality of synchronization messages having at least two types of synchronization messages, where at least one type of synchronization message is valid and where at least one type of synchronization message is invalid and where the at least two types of synchronization messages are time division multiplexed using an uneven distribution.

7. The method of claim 6, wherein the at least two types of synchronization messages contain data specifying a same protocol revision.

8. The method of claim 7, wherein the invalid type of synchronization message does not conform to the protocol revision specified in the synchronization message.

9. The method of claim 8, wherein the invalid type of synchronization message has an incorrect length.

10. The method of claim 8, wherein the invalid type of synchronization message has at least one missing field.

11. The method of claim 8, wherein the invalid type of synchronization message has at least one field containing invalid data.

12. A method for transmitting synchronization messages, comprising the steps of:
transmitting a plurality of synchronization messages having at least two types of synchronization messages, where at least one type of synchronization message is valid and where at least one type of synchronization message is invalid and where the at least two types of synchronization messages contain data specifying a same protocol revision; and
transmitting at least one paging message instructing a receiver conforming to the same protocol revision to reacquire a synchronization message.

13. The method of claim 12, wherein the at least two types of synchronization messages are time division multiplexed using an uneven distribution.

14. The method of claim 13, wherein the invalid type of synchronization message does not conform to the protocol revision specified in the synchronization message.

15. The method of claim 14, wherein the invalid type of synchronization message has an incorrect length.

16. The method of claim 14, wherein the invalid type of synchronization message has at least one missing field.

17. The method of claim 14, wherein the invalid type of synchronization message has at least one field containing invalid data.
